(19) United States
(12) Patent Application Publication
(10) Pub. No.: US 2026/0043525 A1
(43) Pub. Date: Feb. 12, 2026

(54) SYSTEMS AND METHODS FOR STRAY CURRENT PROTECTION OF SMART GAS PIPELINE NETWORK BASED ON INTERNET OF THINGS (IOT)

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei ZHANG, Chengdu (CN); Xiaojun WEI, Chengdu (CN); Yongzeng LIANG, Chengdu (CN)

(73) Assignee: CHENGDU QINCHUAN IOT TECHNOLOGY CO., LTD., Chengdu (CN)

(21) Appl. No.: 19/359,649

(22) Filed: Oct. 15, 2025

(30) Foreign Application Priority Data
Sep. 9, 2025 (CN) 202511280296.1

(51) Int. Cl. F17D 5/00; G06Q 10/20; G06Q 50/06

(52) U.S. Cl. CPC F17D 5/005; G06Q 10/20; G06Q 50/06

(57) ABSTRACT

Provided are a system and method for stray current protection of a smart gas pipeline network based on an Internet of Things (IoT). The system includes a smart gas governmental safety supervision and management platform, a smart gas governmental safety supervision sensing network platform, a smart gas governmental safety supervision object platform. The smart gas governmental safety supervision object platform includes a gas company management platform configured to: at a predetermined interval, determine a potential monitoring area of a target gas pipeline based on pipeline data of the target gas pipeline; obtain historical maintenance data of the potential monitoring area; determine a potential monitoring parameter for the potential monitoring area based on the historical maintenance data; obtain a potential difference distribution within the potential monitoring area through the potential monitoring parameter; determine, based on the potential difference distribution, a discharge parameter of discharge protection equipment within the potential monitoring area.

### CROSS-REFERENCE TO RELATED APPLICATIONS

This application claims priority to Chinese Patent Application No. 202511280296.1, filed on Sep. 9, 2025, the entire content of which is hereby incorporated by reference.

### TECHNICAL FIELD

The present disclosure relates to the field of current protection of a gas pipeline network, and in particular, to a system and method for stray current protection of a smart gas pipeline network based on an Internet of Things (IoT).

### BACKGROUND

The stray current refers to an electrical current that flows irregularly along an uncertain path. When a gas pipeline is subjected to the stray current, it may experience damage, corrosion, and other adverse effects. At present, the stray current protection in the gas pipeline network is mainly realized through the monitoring of stray current in the pipeline, but it does not involve the selection of the monitoring location for monitoring the stray current, and cannot accurately evaluate the impact of the stray current on the gas pipeline.

Therefore, there is an urgent need to provide a system and a method for stray current protection of a smart gas pipeline network based on an Internet of Things (IoT), to efficiently determine monitoring locations of the gas pipeline network for monitoring the stray current, and to quickly obtain the potential changes in the monitoring locations to accurately determine whether the stray current occurs, and to make targeted stray current discharge programs.

### SUMMARY

One or more embodiments of the present disclosure provide a system for stray current protection of a smart gas pipeline network based on an Internet of Things (IoT). The system includes: a smart gas governmental safety supervision and management platform, a smart gas governmental safety supervision sensing network platform, a smart gas governmental safety supervision object platform, a gas company sensing network platform, and a smart gas equipment object platform that are communication-connected. The smart gas governmental safety supervision object platform includes a gas company management platform, wherein the gas company management platform includes a data center, and the gas company management platform is configured to: at a predetermined interval, determine a potential monitoring area of a target gas pipeline based on pipeline data of the target gas pipeline, the potential monitoring area including a plurality of potential monitoring points; obtain historical maintenance data of the potential monitoring area through the data center; determine a potential monitoring parameter for the potential monitoring area based on the historical maintenance data; obtain a potential difference distribution within the potential monitoring area through the smart gas equipment object platform based on the potential monitoring parameter; and determine, based on the potential difference distribution, a discharge parameter of discharge protection equipment within the potential monitoring area, and generate a discharge instruction to be sent to the smart gas equipment object platform for controlling the discharge protection equipment to carry out discharge.

One or more embodiments of the present disclosure provide a method for stray current protection of a smart gas pipeline network based on an Internet of Things (IoT), wherein the method is executed by a gas company management platform in a system for stray current protection of a smart gas pipeline network based on IoT. The method includes: at a predetermined interval, determining a potential monitoring area of a target gas pipeline based on pipeline data of the target gas pipeline, the potential monitoring area including a plurality of potential monitoring points; obtaining historical maintenance data of the potential monitoring area through a data center; determining a potential monitoring parameter for the potential monitoring area based on the historical maintenance data; obtaining a potential difference distribution within the potential monitoring area through the smart gas equipment object platform, based on the potential monitoring parameter; and determining, based on the potential difference distribution, a discharge parameter of discharge protection equipment within the potential monitoring area, and generating a discharge instruction to be sent to the smart gas equipment object platform for controlling a discharge protection equipment to carry out discharge.

One or more embodiments of the present disclosure provide a non-transitory computer-readable storage medium storing computer instructions, wherein when reading the computer instructions in the storage medium, a computer implements the method for stray current protection of a smart gas pipeline network based on IoT.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram of an exemplary structure of platforms of a system for stray current protection of a smart gas pipeline network based on an Internet of Things (IoT) according to some embodiments of the present disclosure;

FIG. 2 is a flowchart of an exemplary process for stray current protection of a smart gas pipeline network based on an Internet of Things (IoT) according to some embodiments of the present disclosure;

FIG. 3 is a schematic diagram of an exemplary process for determining a potential monitoring parameter according to some embodiments of the present disclosure; and

FIG. 4 is an exemplary schematic diagram of a risk assessment model according to some embodiments of the present disclosure.

### DETAILED DESCRIPTION

In order to more clearly illustrate the technical solutions of the embodiments of the present disclosure, a brief description of the accompanying drawings that need to be used in the description of the embodiments is provided below. The accompanying drawings do not represent the entirety of the embodiments.

It should be understood that as used herein, “system”, “device”, “unit,” and/or “module” as used herein is a method for distinguishing between different components, elements, parts, sections, or assemblies at different levels. The words may be replaced by other expressions if other words accomplish the same purpose.

Unless the context clearly suggests an exception, “one”, “a”, and/or “the” do not refer specifically to the singular, but may also include the plural. Generally, the terms “including” and “comprising” suggest only the inclusion of clearly identified operations and elements. In general, the terms “including” and “comprising” only suggest the inclusion of explicitly identified operations and elements that do not constitute an exclusive list, and the method or apparatus may also include other operations or elements.

When describing the operations performed in the embodiments of the present disclosure in terms of operations, the order of the operations is interchangeable, the operations may be omitted, and other operations may be included in the process, unless otherwise specified.

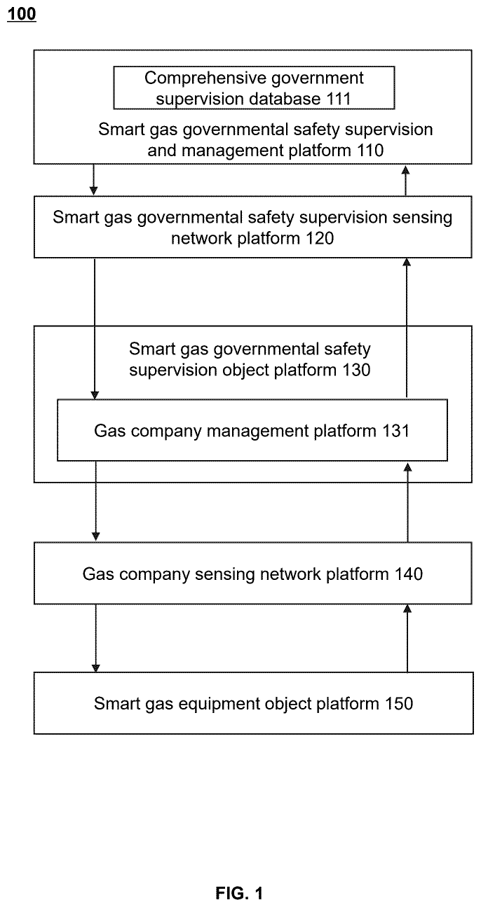

FIG. 1 is a schematic diagram of an exemplary structure of platforms of a system for stray current protection of a smart gas pipeline network based on an Internet of Things (IoT) according to some embodiments of the present disclosure.

As shown in FIG. 1, the system for stray current protection of a smart gas pipeline network based on an Internet of Things (IoT) 100 includes a smart gas governmental safety supervision and management platform 110, a smart gas governmental safety supervision sensing network platform 120, a smart gas governmental safety supervision object platform 130, a gas company sensing network platform 140, and a smart gas equipment object platform 150 that are communication-connected.

The smart gas governmental safety supervision and management platform 110 is an integrated management platform for the government to manage information related to gas safety. In some embodiments, the smart gas governmental safety supervision and management platform is configured on a server of a government department. The smart gas governmental safety supervision and management platform includes a comprehensive government supervision database 111. The comprehensive government supervision database 111 is configured to store and manage information and/or data related to the smart gas governmental safety supervision and management platform.

The smart gas governmental safety supervision sensing network platform 120 refers to a platform used by the government to manage sensor information related to gas safety. In some embodiments, the smart gas governmental safety supervision sensing network platform is configured as a communication network or gateway.

The smart gas governmental safety supervision object platform 130 refers to a platform used by the government to supervise the generation of information and control the execution of information.

In some embodiments, the smart gas governmental safety supervision object platform 130 includes a gas company management platform 131.

The gas company management platform 131 refers to a comprehensive management platform for gas company information. In some embodiments, the gas company management platform is configured on a server within the gas company.

In some embodiments, the gas company management platform 131 includes a data center. The data center is configured to store and manage information and/or data related to the system for stray current protection of a smart gas pipeline network based on an Internet of Things (IoT) 100, e.g., historical maintenance data, pipeline data, etc.

The gas company sensing network platform 140 refers to a platform for the integrated management of gas company sensor information. In some embodiments, the gas company sensing network platform is configured as a communication network or gateway.

The smart gas equipment object platform 150 refers to a functional platform for sensing information generation and controlling information execution.

In some embodiments, the smart gas equipment object platform 150 includes at least one of electrochemical sensors, monitoring devices, discharge protection equipment, appurtenant facilities, etc.

The electrochemical sensors are configured to obtain corrosion data for a gas pipeline. In some embodiments, the electrochemical sensors are disposed at any feasible locations within the gas pipeline.

The monitoring devices are configured to perform potential monitoring of potential monitoring points. The potential difference refers to a difference in potential change. In some embodiments, the monitoring devices are disposed around the potential monitoring points and perform potential monitoring on one or more potential monitoring points through movement.

The discharge protection equipment is configured to discharge a stray current around the gas pipeline. The stray current refers to a current in the gas pipeline that moves irregularly along an uncertain path. In some embodiments, the discharge protection equipment is disposed at current facilities around the potential monitoring points to discharge stray currents from the one or more potential monitoring points. The current facilities refer to facilities that may generate the stray currents. For example, the current facilities include high voltage lines, etc.

The appurtenant facilities refer to facilities related to gas transportation. In some embodiments, the appurtenant facilities include at least one of a gas pressure regulating compressor, an electromagnetic valve of the gas pipeline, a temperature control device of the gas pipeline, etc.

In some embodiments, the gas company management platform may assign identification codes to the above equipment or facilities to differentiate between different equipment or facilities.

In some embodiments, the system for stray current protection of a smart gas pipeline network based on an Internet of Things (IoT) 100 may further include a processor. In some embodiments, the processor is configured to process information and/or data related to the system for stray current protection of a smart gas pipeline network based on an Internet of Things (IoT) 100. The processor includes a Central Processing Unit (CPU), an Application-Specific Instruction Processor (ASIP), a Graphics Processing Unit (GPU), or any combination thereof.

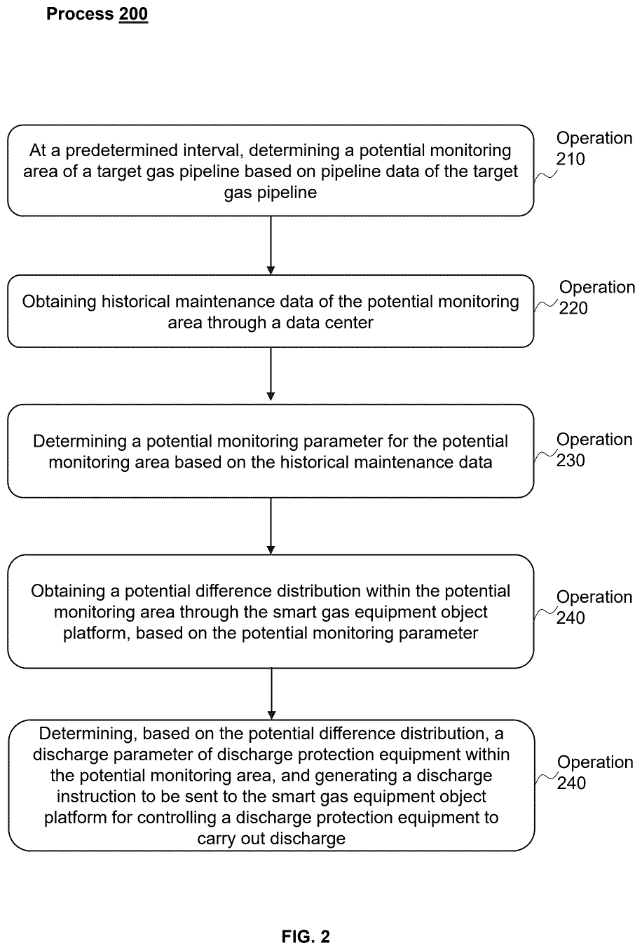

Detailed descriptions of the foregoing may be found in the related descriptions of FIG. 2-FIG. 4.

In some embodiments of the present disclosure, the system for stray current protection of a smart gas pipeline network based on an Internet of Things (IoT) can form a closed loop of information operation between various functional platforms, enabling coordinated and regular operation to realize the informatization and intelligence of the smart gas stray current protection.

FIG. 2 is a flowchart of an exemplary process for stray current protection of a smart gas pipeline network based on an Internet of Things (IoT) according to some embodiments of the present disclosure. In some embodiments, process 200 is performed by a gas company management platform of a system for stray current protection of a smart gas pipeline network based on an Internet of Things (IoT). As shown in FIG. 2, process 200 includes the following operations.

Operation 210, at a predetermined interval, determining a potential monitoring area of a target gas pipeline based on pipeline data of the target gas pipeline.

The predetermined interval is predetermined based on historical experience. In some embodiments, at the predetermined interval, the gas company management platform executes process 200.

The target gas pipeline refers to a gas pipeline that requires potential monitoring. In some embodiments, the gas company management platform may divide the target gas pipeline into a plurality of sub-areas according to a geographic location or latitude and longitude, each sub-area corresponding to a portion of the target gas pipeline.

In some embodiments, a plurality of potential monitoring points are predetermined within each sub-area. The potential monitoring points refer to points within the sub-areas where potential monitoring is performed. The potential monitoring points are predetermined based on actual potential monitoring needs. The potential monitoring refers to the monitoring of potential changes at one or more locations. The potential change may be expressed by a difference between an upper potential limit and a lower potential limit (i.e., a potential difference).

The pipeline data refers to data related to gas pipelines. In some embodiments, the pipeline data includes at least one of a pipeline material, a pipeline corrosion protection layer material, a pipeline thickness, a pipeline size, or the like. The pipeline data of the target gas pipeline includes pipeline data of the plurality of sub-areas corresponding to the target gas pipeline.

In some embodiments, the gas company management platform may obtain the pipeline data through a data center. The pipeline data is uploaded by a technician for storage in the data center. The pipeline data changes due to pipeline replacement or maintenance, technicians may update the pipeline data in real time based on circumstances of pipeline replacement or maintenance.

The potential monitoring area refers to an area on the target gas pipeline that requires potential monitoring.

In some embodiments, the gas company management platform determines a plurality of potential monitoring areas of the target gas pipeline based on the pipeline data of the target gas pipeline. For example, based on the pipeline data of the plurality of sub-areas of the target gas pipeline, the gas company management platform queries labels in a first predetermined table that correspond to the pipeline data of the sub-areas, and determines whether the sub-areas are the potential monitoring areas based on the labels. The first predetermined table includes a plurality of pieces of pipeline data and corresponding labels. The labels include requiring potential monitoring and no requiring potential monitoring. The gas company management platform identifies the sub-areas corresponding to the pipeline data labeled as requiring potential monitoring as the potential monitoring areas.

In some embodiments, the first predetermined table is predetermined based on historical experience.

Operation 220, obtaining historical maintenance data of the potential monitoring area through the data center.

The historical maintenance data refers to information related to the maintenance of the gas pipeline during a predetermined historical period. The predetermined historical period is predetermined based on historical experience. In some embodiments, the historical maintenance data includes historical corrosion data, historical inspection data, etc. The gas company management platform obtains the historical maintenance data through the data center.

The historical corrosion data refers to corrosion data of gas pipelines during the predetermined historical period. The corrosion data includes corrosion locations and corresponding corrosion rates, etc.

The historical inspection data refers to inspection data of the gas pipelines during the predetermined historical period. The inspection data includes inspection locations and corresponding counts of inspections.

In some embodiments, the corrosion data is acquired by electrochemical sensors and uploaded to the data center for storage via a gas company sensing network platform. The inspection data is uploaded by a technician to the data center for storage. More descriptions regarding the electrochemical sensor may be found in FIG. 1 and relevant descriptions.

Operation 230, determining a potential monitoring parameter for the potential monitoring area based on the historical maintenance data.

The potential monitoring parameter refers to a parameter when potential monitoring is performed on the potential monitoring area. In some embodiments, the potential monitoring parameter includes a monitoring point distribution of potential monitoring points to be activated and a potential monitoring manner of the potential monitoring points to be activated. The potential monitoring manner includes at least one of a direct current potential difference manner, an alternating current potential difference manner, or the like

The monitoring point distribution is used to characterize the location distribution of the potential monitoring points to be activated. It may be understood that each time the potential monitoring area is monitored, the plurality of potential monitoring points within the potential monitoring area have been activated partially or completely, to satisfy the potential monitoring requirements.

In some embodiments, the gas company management platform determines the potential monitoring parameter of the potential monitoring area in a plurality of ways based on the historical maintenance data. For example, the gas company management platform constructs first clustering vectors based on the historical maintenance data of a plurality of historical target gas pipelines and uses the corresponding historical potential monitoring parameters as labels of the first clustering vectors, and constructs a first target vector based on the historical maintenance data of the target gas pipeline. The gas company management platform clusters the first clustering vectors and the first target vector using the historical maintenance data as the clustering indicator to obtain a plurality of first clustering clusters, identifies a first clustering cluster containing the first target vector as a first target clustering cluster, and determines the potential monitoring parameter based on the first target clustering cluster. The gas company management platform may screen a first clustering vector that satisfies a screening condition among all the first clustering vectors in the first target clustering cluster and use a label of the first clustering vector as the potential monitoring parameter corresponding to the potential monitoring area. The screening condition includes that a historical target gas pipeline corresponding to the first clustering vector has the fastest reduction in historical corrosion rate after subsequent discharge based on a corresponding historical potential difference.

The historical potential monitoring parameter includes a monitoring point distribution of potential monitoring points that were actually turned on and used during the potential monitoring of the historical target gas pipeline, and the potential monitoring manner of each potential monitoring point.

In some embodiments, the historical maintenance data further includes a historical potential difference. The historical potential difference refers to a potential difference distribution over the predetermined historical period.

The potential difference distribution is used to characterize the distribution of potential differences corresponding to the plurality of potential monitoring points, including the locations of the plurality of potential monitoring points and the corresponding potential differences. More descriptions regarding a process for obtaining the potential difference distribution and a process for controlling discharge protection equipment to perform discharge based on the potential difference distribution may be found in operations 240 and 250 and relevant descriptions.

In some embodiments, the gas company management platform obtains the historical potential monitoring parameter and the historical potential difference through the data center.

In some embodiments, the gas company management platform may also determine a stray current risk of the plurality of potential monitoring points based on the historical potential difference, and determine the monitoring point distribution and the potential monitoring manner based on the stray current risk.

The stray current risk is used to characterize the likelihood of a stray current occurring in the gas pipeline at a predetermined future period. The predetermined future period is predetermined based on historical experience. In some embodiments, the stray current risk may be expressed in a class or a numerical value, where the higher the class or numerical value, the higher the stray current risk.

In some embodiments, the gas company management platform determines the stray current risk of the plurality of potential monitoring points in a plurality of ways based on the historical potential difference. For example, the gas company management platform constructs second clustering vectors based on the historical potential difference of the plurality of historical target gas pipelines, and uses corresponding historical stray current distributions as labels of the second clustering vectors, and constructs a target vector based on the historical potential difference of the target gas pipeline. The gas company management platform clusters the second clustering vectors and the second target vector using the historical potential difference as a clustering indicator to obtain a plurality of second clustering clusters, identifies a second clustering cluster containing the second target vector as a second target clustering cluster, and determines the stray current risk of the plurality of potential monitoring points based on the second target clustering cluster.

The historical stray current distribution refers to a distribution of locations of potential monitoring points that actually generated the stray current within the historical target gas pipeline at a second historical time after the historical potential difference corresponding to the historical target gas pipeline is determined at a first historical time. The first historical time is earlier than the second historical time.

In some embodiments, in response to a difference between the historical potential difference and a corresponding standard potential difference at the potential monitoring point exceeding a difference threshold, the gas company management platform determines that the stray current is present at the potential monitoring point. The standard potential difference refers to a potential difference when there is no stray current at the potential monitoring point. One potential monitoring point corresponds to one standard potential difference. The standard potential difference is obtained by technician measurements and entered into the data center for storage. The difference threshold is predetermined based on historical experience.

In some embodiments, for each potential monitoring point, the gas company management platform may screen a plurality of second cluster vectors in the second target clustering cluster, calculate a ratio of a count of second cluster vectors in which the stray current is generated at similar monitoring points to a total count of second cluster vectors, and determine the ratio as the stray current risk at the potential monitoring point.

The similar monitoring points refer to potential monitoring points in the second clustering vectors that are similar in location to potential monitoring points in the second target vector. In some embodiments, the gas company management platform may overlap the potential monitoring area with the historical potential monitoring area corresponding to the second clustering vectors, establish a coordinate system with the center as the origin, and determine the potential monitoring points that satisfy a similarity condition in the second clustering vectors within the coordinate system as the similar monitoring points. The similarity condition includes a distance between the potential monitoring point in the second clustering vectors and the potential monitoring point in the second target vector is less than a distance threshold. The distance threshold is predetermined based on historical experience.

In some embodiments, the gas company management platform obtains the historical potential difference and the historical stray current distribution through the data center.

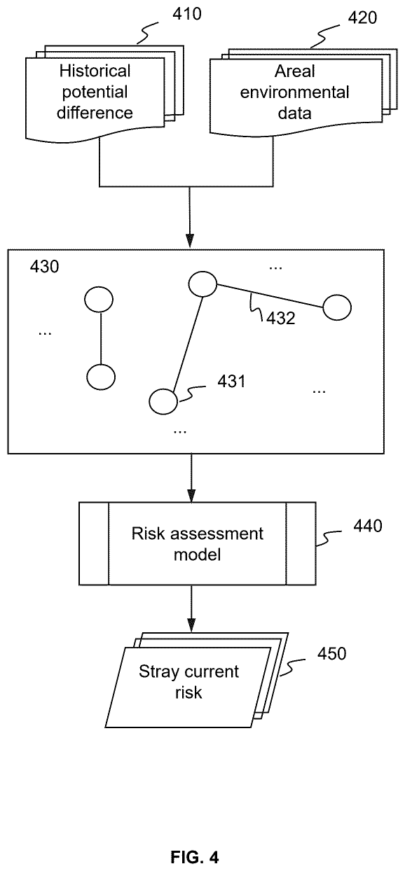

In some embodiments, the gas company management platform may also construct a current protection map corresponding to the potential monitoring area based on the historical potential difference and areal environmental data, and determine the stray current risk through a risk assessment model based on the current protection map, as described in FIG. 4.

In some embodiments, the gas company management platform identifies, based on the stray current risk of the plurality of potential monitoring points, a potential monitoring point with a stray current risk that exceeds a first predetermined risk threshold as a potential monitoring point to be activated, determines a potential monitoring manner corresponding to the stray current risk by querying a second predetermined table, and constructs the monitoring point distribution based on the location of the potential monitoring point to be activated and the corresponding potential monitoring manner.

The second predetermined table is predetermined based on historical experience and includes a plurality of stray current risks and potential monitoring manners corresponding to different stray current risks.

In some embodiments, the first predetermined risk threshold may be determined based on historical experience and may also be negatively correlated to an average corrosion rate in the potential monitoring area. The gas company management platform calculates an average of the corrosion rate at each corrosion location in the historical corrosion data as the average corrosion rate.

It may be understood that when the average corrosion rate of the current monitoring area is larger, it means that the potential monitoring area is more likely to be corroded because of the stray current, and the first predetermined risk threshold is reduced to set up more potential monitoring points to be activated, which will ensure the comprehensiveness of potential monitoring.

By taking into account the historical potential difference, the stray current risk at each potential monitoring point can be more accurately assessed, and based on the stray current risk, it is possible to select the potential monitoring point and the potential monitoring manner that can better ensure the comprehensiveness of potential monitoring and thus conduct the potential monitoring more comprehensively, which is conducive to making targeted stray current discharge programs.

In some embodiments, the gas company management platform may also determine monitoring frequencies of monitoring devices corresponding to the plurality of potential monitoring points based on the stray current risk. More descriptions regarding the monitoring devices may be found in FIG. 1 and relevant descriptions.

In some embodiments, the gas company management platform determines, based on the stray current risk of a single potential monitoring point, a monitoring frequency corresponding to the stray current risk as the monitoring frequency of the monitoring device corresponding to the potential monitoring point by querying the third predetermined table.

The third predetermined table is predetermined based on historical experience and includes a plurality of stray current risks and the monitoring frequencies corresponding to the monitoring devices.

Determining the monitoring frequencies of the monitoring devices by the stray current risk enables intensive monitoring of the potential monitoring points that are more likely to have stray currents, which in turn enables timely determination of whether or not stray currents occur.

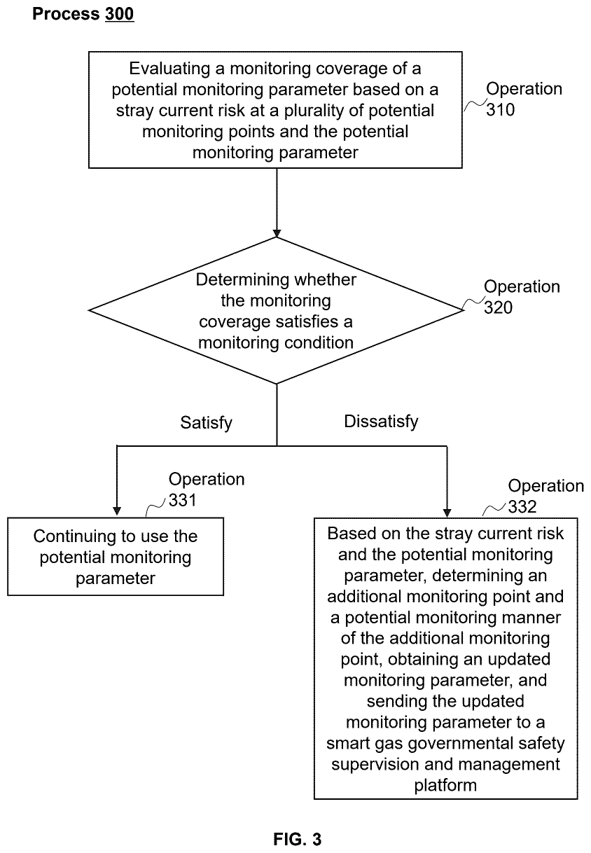

In some embodiments, the gas company management platform may evaluate a monitoring coverage of the potential monitoring parameter based on the stray current risks at the plurality of potential monitoring points and the potential monitoring parameter, and determine whether to adjust the potential monitoring parameter based on the monitoring coverage. More descriptions regarding this part may be found in FIG. 3 and relevant descriptions.

Operation 240, obtaining a potential difference distribution within the potential monitoring area through a smart gas equipment object platform based on the potential monitoring parameter.

More descriptions regarding the potential difference distribution may be found in operation 230 and relevant descriptions.

In some embodiments, the gas company management platform sends the potential monitoring parameter through the gas company sensing network platform to the monitoring devices of the smart gas equipment object platform, and the monitoring devices acquires the data through movement to obtain the potential difference of each potential monitoring point included in the potential monitoring parameters and uploads the potential difference of each potential monitoring point to the gas company management platform via the gas company sensing network platform, and the gas company management platform constructs the potential difference distribution based on the location of each potential monitoring point and the corresponding potential difference.

Operation 250, determining, based on the potential difference distribution, a discharge parameter of discharge protection equipment within the potential monitoring area, and generating a discharge instruction to be sent to the smart gas equipment object platform for controlling discharge protection equipment to carry out discharge.

More descriptions regarding the discharge protection equipment may be found in FIG. 1 and relevant descriptions.

The discharge parameter refers to a parameter that controls the discharge protection equipment to perform the discharge. In some embodiments, the discharge parameter includes discharge protection equipment that needs to be turned on and a corresponding discharge duration, etc.

In some embodiments, the gas company management platform may identify a plurality of potential monitoring points in the potential difference distribution with a potential difference exceeding a potential difference threshold as target monitoring points, identify the discharge protection equipment closest to the target monitoring points as the discharge protection equipment that needs to be turned on, and determine the discharge duration based on the stray current risks of the target monitoring points. The length of the discharge duration is positively correlated to the stray current risks of the target monitoring points. The potential difference threshold is positively correlated to a thickness of a pipeline in the potential monitoring area where the potential monitoring points are located.

In some embodiments, the gas company management platform generates the discharge instruction based on the discharge parameter and sends the discharge instruction to the smart gas equipment object platform via the gas company sensing network platform to control the discharge protection equipment to perform the discharge.

In some embodiments, the gas company management platform may determine, by means of the operations 220-250 described above, the potential monitoring parameter of each potential monitoring area and obtain the potential difference distribution within each potential monitoring area, and then determine the discharge parameter of each potential monitoring area to control the discharge protection equipment to perform the discharge.

By targeting the pipeline data in different areas, it can efficiently determine the areas that need to be monitored for the stray current, and quickly determine the potential monitoring parameter by the historical maintenance data, thereby promptly obtaining the potential change at each potential monitoring point. This can accurately determine whether the stray current occurs, and to make targeted stray current discharge programs.

FIG. 3 is a schematic diagram of an exemplary process for determining a potential monitoring parameter according to some embodiments of the present disclosure. In some embodiments of the present disclosure, process 300 is performed by a gas company management platform. As shown in FIG. 3, process 300 includes the following operations.

Operation 310, evaluating a monitoring coverage of a potential monitoring parameter based on a stray current risk at a plurality of potential monitoring points and the potential monitoring parameter.

More descriptions regarding the potential monitoring points, the stray current risk, and the potential monitoring parameter may be found in FIG. 2 and relevant descriptions.

The monitoring coverage is used to characterize the comprehensiveness of monitoring a target gas pipeline using the potential monitoring parameter.

In some embodiments, the gas company management platform determines the monitoring coverage of the potential monitoring parameter in a plurality of ways based on the stray current risk at the plurality of potential monitoring points and the potential monitoring parameter. For example, the gas company management platform counts a ratio of a count of potential monitoring points in the potential monitoring parameter whose stray current risk exceeds a predetermined risk threshold to a total count of potential monitoring points in the potential monitoring parameter as the monitoring coverage. More descriptions regarding the predetermined risk threshold may be found in FIG. 2 and relevant descriptions.

Operation 320, determining whether the monitoring coverage satisfies a monitoring condition.

The monitoring condition refers to a condition used to determine whether or not a new potential monitoring point is required. In some embodiments, the monitoring condition may include that the monitoring coverage is not less than a coverage threshold. The coverage threshold is determined based on a priori experience.

In some embodiments, the coverage threshold may also be positively correlated to an average of the stray current risk at the plurality of potential monitoring points within the potential monitoring area. It may be understood that the greater the average value of the stray current risk of the plurality of potential monitoring points, the greater the instability of the potential monitoring area, and that increasing the coverage threshold can relax the conditions for adding new potential monitoring points, thereby determining more potential monitoring points for more comprehensive potential monitoring.

In some embodiments, the gas company management platform determines whether the monitoring coverage satisfies the monitoring condition, and in response to the monitoring coverage satisfying the monitoring condition, operation 331 is carried out, and in response to the monitoring coverage not satisfying the monitoring condition, operation 332 is carried out.

Operation 331, continuing to use the potential monitoring parameter.

In some embodiments, in response to the monitoring coverage meeting the monitoring condition, the gas company management platform may continue to use the potential monitoring parameter determined in operation 230 and further carry out operation 240.

Operation 332, based on the stray current risk and the potential monitoring parameter, determining an additional monitoring point and a potential monitoring manner of the additional monitoring point, obtaining an updated monitoring parameter, and sending the updated monitoring parameter to a smart gas governmental safety supervision and management platform.

The updated monitoring parameter refers to a re-determined potential monitoring parameter. In some embodiments, the gas company management platform combines the additional monitoring point and the potential monitoring manner of the additional monitoring point with the potential monitoring parameter to form the updated monitoring parameter.

In some embodiments, the gas company management platform determines the additional monitoring point and the potential monitoring manner of the additional monitoring point in a plurality of ways based on the stray current risk and the potential monitoring parameter. For example, the gas company management platform identifies one or more potential monitoring points in the potential monitoring area with a stray current risk exceeds a second predetermined risk threshold and are not included in the potential monitoring parameter as one or more additional monitoring points. The second predetermined risk threshold is predetermined based on historical experience. The second predetermined risk threshold is less than the first predetermined risk threshold.

In some embodiments, the gas company management platform determines, based on the stray current risk at the additional monitoring point, the potential monitoring manner of the additional monitoring point, and the specific manner of determining is described in connection with operation 230.

In some embodiments, the gas company management platform may also determine the additional monitoring point and the potential monitoring manner of the additional monitoring point to obtain the updated monitoring parameter based on the corrosion impact values corresponding to each potential monitoring point at the plurality of predetermined time points.

The corrosion impact value is used to characterize the magnitude of the corrosion of the stray current on the potential monitoring point. In some embodiments, the corrosion impact values corresponding to each potential monitoring point at the plurality of predetermined time points may be represented in the form of a sequence, denoted as a corrosion impact value sequence.

In some embodiments, for each of the plurality of potential monitoring points, the gas company management platform determines corrosion impact values corresponding to the plurality of predetermined time points (i.e., the corrosion impact value sequence) based on potential differences of the potential monitoring point at the plurality of predetermined time points, and determines a discharge device distribution of the discharge protection equipment based on the corrosion impact values.

Each of the plurality of predetermined time points refers to a time point in a different predetermined interval. The predetermined time points are predetermined based on historical experience, and each predetermined time point is arranged in chronological order. The first of the plurality of predetermined time points is not required to determine the corrosion impact value.

More descriptions regarding the predetermined interval and the potential difference may be found in FIG. 2 and relevant descriptions.

In some embodiments, when the potential monitoring point is different from the historical potential monitoring point corresponding to the predetermined time point, the gas company management platform may take the potential difference corresponding to the historical potential monitoring point nearest to the potential monitoring point at the predetermined time point as the potential difference corresponding to the potential monitoring point at the predetermined time point.

In some embodiments, the gas company management platform calculates a difference between potential differences at two neighboring predetermined time points, and takes a ratio between the difference and the potential difference at the previous predetermined time point of the two neighboring predetermined time points as the corrosion impact value of the latter predetermined time point of the two neighboring predetermined time points. The corrosion impact values of the potential monitoring points at the plurality of predetermined time points are determined by the above manner.

The discharge device distribution refers to a distribution of the installation locations of the discharge protection equipment.

In some embodiments, the gas company management platform may determine installation locations of the discharge protection equipment based on the corrosion impact value sequence of the potential monitoring point, and generate the discharge device distribution based on the installation locations. For example, the gas company management platform selects a corrosion impact value sequence whose corrosion impact values gradually increase with successive predetermined time points, and determines a location of the potential monitoring point corresponding to the corrosion impact value sequence as the installation location. As another example, the gas company management platform counts the corrosion impact value closest to a current time point in the corrosion impact value sequence, and if the corrosion impact value exceeds a predetermined impact threshold, a location of the potential monitoring point corresponding to the corrosion impact value sequence is determined as the installation location. The predetermined impact threshold may be predetermined based on a priori experience.

More descriptions regarding the discharge protection equipment may be found in FIG. 1 and relevant descriptions.

In some embodiments of the present disclosure, by determining the corrosion impact values corresponding to the potential monitoring point at the plurality of predetermined time points, it is possible to effectively determine whether or not the impact of the stray current on the gas pipeline is increased, so as to reasonably set the location of the discharge protection equipment and better control the discharge protection equipment to discharge a current.

In some embodiments, the gas company management platform determines, based on the corrosion impact values corresponding to the potential monitoring point at the plurality of predetermined time points, the additional monitoring point and the potential monitoring manner of the additional monitoring point in a plurality of ways.

For example, the gas company management platform may determine whether the fluctuation of the corrosion impact values of the potential monitoring point exceeds a predetermined fluctuation threshold. In response to the fluctuation of the corrosion impact values exceeding the predetermined fluctuation threshold, a midpoint location between the potential monitoring point and its neighboring potential monitoring point is determined as the location of the additional monitoring point, and the potential monitoring manner of the additional monitoring point is directly determined as the direct current potential difference manner.

The fluctuation of the corrosion impact values refers to a change in the corrosion impact value. In some embodiments, the fluctuation of the corrosion impact values may be represented by an average of the differences of neighboring corrosion impact values in the corrosion impact value sequence. The predetermined fluctuation threshold may be determined based on a priori experience.

In some embodiments, the predetermined fluctuation threshold may also be negatively correlated to a count of edges in a current protection map. It is to be understood that a larger count of edges in the current protection map indicates a more complex connectivity relationship among the potential monitoring points in the potential monitoring area, as well as greater instability. Reducing the predetermined fluctuation threshold can facilitate the addition of potential monitoring points, thus realizing comprehensive monitoring.

More descriptions regarding the current protection map may be found in FIG. 4 and relevant descriptions.

In some embodiments of the present disclosure, by considering the corrosion impact values at different predetermined time points, potential monitoring points can be added at locations susceptible to corrosion by the stray current, and suitable potential monitoring manners can be set up, to improve the accuracy of potential monitoring.

In some embodiments, the gas company management platform determines the additional monitoring point and the potential monitoring manner of the additional monitoring point to obtain the updated monitoring parameter, and sends the potential monitoring parameter to the smart gas governmental safety supervision and management platform through the smart gas governmental safety supervision sensing network platform, which is confirmed by a manager of the smart gas governmental safety supervision and management platform.

Based on the stray current risk, evaluating the monitoring coverage of the potential monitoring parameter can enable timely addition of monitoring points, preventing the overlooked detection of points with higher stray current risks, and thereby providing a more comprehensive monitoring of the potential monitoring area.

It should be noted that the foregoing description of the process 200 and the process 300 is intended to be exemplary and illustrative only, without limiting the scope of application of the present disclosure. For a person skilled in the art, various corrections and changes can be made to the processes under the guidance of this present disclosure. However, these corrections and changes remain within the scope of this present disclosure.

FIG. 4 is an exemplary schematic diagram of a risk assessment model according to some embodiments of the present disclosure. In some embodiments, the gas company management platform may construct a current protection map 430 corresponding to a potential monitoring area based on a historical potential difference 410 and areal environmental data 420, and determine a stray current risk 450 through a risk assessment model 440 based on the current protection map 430. More descriptions regarding the historical potential difference and the stray current risk may be found in FIG. 2 and relevant descriptions.

The areal environmental data refers to data related to the environment of the potential monitoring area. In some embodiments, a single potential monitoring area corresponds to a set of areal environmental data, and the set of areal environmental data includes environmental data for a plurality of potential monitoring points within the potential monitoring area. The environmental data refers to data related to the environment of the potential monitoring point.

In some embodiments, the environmental data includes physical spatial data and soil parameters. The physical spatial data refers to data related to the physical space surrounding the potential monitoring point. For example, the physical spatial data includes a distance between the potential monitoring point and a high-voltage line, whether a high-speed rail exists near the potential monitoring point, etc. The soil parameters refer to parameters related to the soil around the potential monitoring point, e.g., a soil resistivity, a soil temperature, etc.

In some embodiments, the gas company management platform obtains the areal environmental data of the potential monitoring area through the smart gas governmental safety supervision and management platform. The smart gas governmental safety supervision and management platform obtains the areal environmental data through manual collection, etc.

The current protection map refers to a map structure that characterizes the connection relationships between the plurality of potential monitoring points in the potential monitoring area. The graph structure refers to a data structure consisting of nodes and edges, where edges connect nodes, and the nodes and edges may have features. In some embodiments, the current protection map is an undirected map.

In some embodiments, the gas company management platform constructs the current protection map corresponding to the potential monitoring area based on the historical potential difference and the areal environmental data. The nodes of the current protection map include potential monitoring points within the potential monitoring area (e.g., a node 431, etc.), and the node features include a historical potential difference and environmental data of the potential monitoring point.

The edges of the current protection map may characterize the connectivity between the nodes. In some embodiments, the gas company management platform may determine the edges of the current protection map based on the connection relationship between two nodes. For example, if two nodes are located on a gas pipeline, then an edge (e.g., an edge 432, etc.) exists between the two nodes. As another example, if the two nodes are located on different gas pipelines, no edge exists between the two nodes. The edge feature includes pipeline data of the gas pipeline where the node is located. More descriptions regarding the pipeline data may be found in FIG. 2 and relevant descriptions. The gas company management platform constructs, through the above manner, current protection maps corresponding to different potential monitoring areas based on the historical potential difference and the areal environmental data of the different potential monitoring areas, respectively, and determines stray current risks in different potential monitoring areas based on the current protection map through the risk assessment model.

In some embodiments, the node features further include distances between the node and appurtenant facilities within a gas pipeline and historical current data corresponding to the appurtenant facilities. More descriptions regarding the appurtenant facilities may be found in FIG. 1 and relevant descriptions.

The distances between the node and the appurtenant facilities within the gas pipeline may be expressed by the average of the distances between the potential monitoring point corresponding to the node and a plurality of appurtenant facilities within a predetermined distance range. The predetermined distance range may be predetermined based on a priori experience. In some embodiments, the gas company management platform may calculate the distances between the potential monitoring point and the appurtenant facilities based on the locations of the potential monitoring point and the appurtenant facilities.

The historical current data refers to data related to the stray current generated by the appurtenant facilities in historical times. In some embodiments, the historical current data includes a current magnitude and a generation frequency of the stray current generated by the appurtenant facilities in historical times. In some embodiments, the historical current data may be determined manually using current-measuring instruments (e.g., ammeters, etc.) and uploaded to a data center.

Operation of the appurtenant facilities within the gas pipeline may generate stray currents of varying magnitudes, and the accuracy of predicting the stray current risk can be improved by considering the effect of the appurtenant facilities within the gas pipeline on the stray currents at the potential monitoring points.

The risk assessment model refers to a model used to determine the stray current risk. In some embodiments, the risk assessment model may be a machine learning model. For example, the risk assessment model may include any one or a combination of Graph Neural Network (GNN) or other customized model structures.

In some embodiments, the input to the risk assessment model includes the current protection map, and the output includes the stray current risk at each node in the current protection map.

In some embodiments, the gas company management platform may train the risk assessment model based on a large number of training samples with labels by gradient descent or the like. A training sample includes a sample current protection map, and a label of the training sample includes whether or not the stray current is actually generated at each sample potential monitoring point in the sample current protection map.

In some embodiments, the gas company management platform determines the training samples and the labels based on the historical data. For example, the gas company management platform constructs the sample current protection map based on the historical potential difference and the historical areal environmental data corresponding to the historical potential monitoring area, and determine the label based on whether or not the stray current is actually generated at each sample potential monitoring point. If the sample potential monitoring point actually generates the stray current, the label is 1, and if the sample potential monitoring point actually does not generate the stray current, the label is 0. Whether or not the stray current is actually generated at each sample potential monitoring point is determined by a historical stray current distribution. More descriptions regarding the historical stray current distribution may be found in operation 230 and relevant descriptions.

In some embodiments, the risk assessment model may be obtained by training in the following manner: inputting a plurality of training samples with labels into an initial risk assessment model, constructing a loss function through the labels and prediction results of the initial risk assessment model, iteratively updating the initial risk assessment model based on the loss function, and completing the training of the risk assessment model when the loss function of the initial risk assessment model satisfies a predetermined condition. The predetermined condition may be that the loss function converges, a count of iterations reaches a set value, etc.

By constructing the current protection map, the various data of a large number of potential monitoring points can be organized in a structured manner, and at the same time, by applying the risk assessment model to predict the stray current risk of the potential monitoring points, the topology and relationship information of the current protection map can be better captured, thereby improving the accuracy of predicting the stray current risk.

Some embodiments of the present disclosure further provide a non-transitory computer-readable storage medium storing computer instructions, wherein when reading the computer instructions in the storage medium, a computer implements the method for stray current protection of a smart gas pipeline network based on an Internet of Things (IoT).

In addition, certain features, structures, or characteristics of one or more embodiments of the present disclosure may be suitably combined.

Numbers describing the number of components, attributes, are used in some embodiments, and it should be understood that such numbers used for the description of embodiments, in some examples, use the modifiers “about”, “approximately”, or “generally” is used in some examples. Unless otherwise noted, the terms “about,” “approximate,” or “approximately” indicates that a ±20% variation in the stated number is allowed. Correspondingly, in some embodiments, the numerical parameters used in the present disclosure and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of this present disclosure are approximations, in specific embodiments such values are set to be as precise as practicable.

In the event of any inconsistency or conflict between the descriptions, definitions, and/or use of terminology in the materials cited in this present disclosure and those described herein, the descriptions, definitions, and/or use of terminology in this present disclosure shall prevail.

What is claimed is:

1. A system for stray current protection of a smart gas pipeline network based on an Internet of Things (IoT), wherein the system comprises: a smart gas governmental safety supervision and management platform, a smart gas governmental safety supervision sensing network platform, a smart gas governmental safety supervision object platform, a gas company sensing network platform, and a smart gas equipment object platform that are communication-connected; the smart gas governmental safety supervision object platform includes a gas company management platform;
wherein the gas company management platform includes a data center, and the gas company management platform is configured to:
at a predetermined interval, determine a potential monitoring area of a target gas pipeline based on pipeline data of the target gas pipeline, the potential monitoring area including a plurality of potential monitoring points;
obtain historical maintenance data of the potential monitoring area through the data center;
determine a potential monitoring parameter for the potential monitoring area based on the historical maintenance data;
obtain a potential difference distribution within the potential monitoring area through the smart gas equipment object platform based on the potential monitoring parameter; and
determine, based on the potential difference distribution, a discharge parameter of discharge protection equipment within the potential monitoring area, and generate a discharge instruction to be sent to the smart gas equipment object platform for controlling the discharge protection equipment to carry out discharge.

2. The system of claim 1, wherein the gas company management platform is further configured to:
evaluate a monitoring coverage of the potential monitoring parameter based on a stray current risk at the plurality of potential monitoring points and the potential monitoring parameter;
in response to the monitoring coverage satisfying a monitoring condition, continue to use the potential monitoring parameter; and
in response to the monitoring coverage not satisfying the monitoring condition, based on the stray current risk and the potential monitoring parameter, determine an additional monitoring point and a potential monitoring manner of the additional monitoring point, obtain an updated monitoring parameter, and send the updated monitoring parameter to the smart gas governmental safety supervision and management platform.

3. The system of claim 1, wherein the historical maintenance data includes a historical potential difference, and the potential monitoring parameter includes a monitoring point distribution of a potential monitoring point to be activated and a potential monitoring manner of the potential monitoring point to be activated, and the gas company management platform is further configured to:
determine a stray current risk of the plurality of potential monitoring points based on the historical potential difference; and
determine the monitoring point distribution and the potential monitoring manner based on the stray current risk.

4. The system of claim 3, wherein the gas company management platform is further configured to:
determine monitoring frequencies of monitoring devices corresponding to the plurality of potential monitoring points based on the stray current risk.

5. The system of claim 3, wherein the gas company management platform is further configured to:
construct a current protection map corresponding to the potential monitoring area based on the historical potential difference and areal environmental data; and
determine the stray current risk through a risk assessment model based on the current protection map, the risk assessment model being a machine learning model.

6. The system of claim 5, wherein the current protection map includes a plurality of nodes and edges between the plurality of nodes, node features of the plurality of nodes including distances between the plurality of nodes and appurtenant facilities within a gas pipeline, and historical current data corresponding to the appurtenant facilities.

7. The system of claim 1, wherein the gas company management platform is further configured to:
determine corrosion impact values corresponding to a plurality of predetermined time points based on potential differences of the plurality of potential monitoring points at the plurality of predetermined time points; and
determine a discharge device distribution of the discharge protection equipment based on the corrosion impact values.

8. The system of claim 7, wherein the gas company management platform is further configured to:
determine an additional monitoring point and a potential monitoring manner of the additional monitoring point and obtain an updated monitoring parameter based on the corrosion impact values.

9. A method for stray current protection of a smart gas pipeline network based on an Internet of Things (IoT), wherein the method is executed by a gas company management platform in a system for stray current protection of a smart gas pipeline network based on IoT, the method comprising:
at a predetermined interval, determining a potential monitoring area of a target gas pipeline based on pipeline data of the target gas pipeline, the potential monitoring area including a plurality of potential monitoring points;
obtaining historical maintenance data of the potential monitoring area through a data center;
determining a potential monitoring parameter for the potential monitoring area based on the historical maintenance data;
obtaining a potential difference distribution within the potential monitoring area through the smart gas equipment object platform, based on a potential monitoring parameter; and
determining, based on the potential difference distribution, a discharge parameter of discharge protection equipment within the potential monitoring area, and generating a discharge instruction to be sent to the smart gas equipment object platform for controlling a discharge protection equipment to carry out discharge.

10. The method of claim 9, wherein the method further comprises:
evaluating a monitoring coverage of the potential monitoring parameter based on a stray current risk at the plurality of potential monitoring points and the potential monitoring parameter;
in response to the monitoring coverage satisfying a monitoring condition, continuing to use the potential monitoring parameter; and
in response to the monitoring coverage not satisfying the monitoring condition, based on the stray current risk and the potential monitoring parameter, determining an additional monitoring point and a potential monitoring manner of the additional monitoring point, obtaining an updated monitoring parameter, and sending the updated monitoring parameter to a smart gas governmental safety supervision and management platform.

11. The method of claim 9, wherein the historical maintenance data includes a historical potential difference, and the potential monitoring parameter includes a monitoring point distribution of a potential monitoring point to be activated and a potential monitoring manner of the potential monitoring point to be activated, the determining a potential monitoring parameter for the potential monitoring area based on the historical maintenance data including:
determining a stray current risk of the plurality of potential monitoring points based on the historical potential difference; and
determining the monitoring point distribution and the potential monitoring manner based on the stray current risk.

12. The method of claim 11, wherein the method further comprises:
determining monitoring frequencies of monitoring devices corresponding to the plurality of potential monitoring points based on the stray current risk.

13. The method of claim 11, wherein the determining a stray current risk of the plurality of potential monitoring points based on the historical potential difference includes:
constructing a current protection map corresponding to the potential monitoring area based on the historical potential difference and areal environmental data; and
determining the stray current risk through a risk assessment model based on the current protection map, the risk assessment model being a machine learning model.

14. The method of claim 13, wherein the current protection map includes a plurality of nodes and edges between the plurality of nodes, node features of the plurality of nodes including distances between the plurality of nodes and appurtenant facilities within a gas pipeline, and historical current data corresponding to the appurtenant facilities.

15. The method of claim 9, wherein the method further comprises:
determining corrosion impact values corresponding to a plurality of predetermined time points based on potential differences of the plurality of potential monitoring points at the plurality of predetermined time points; and
determining a discharge device distribution of the discharge protection equipment based on the corrosion impact values.

16. The method of claim 15, wherein the method further comprises:
determining an additional monitoring point and a potential monitoring manner of the additional monitoring point and obtaining an updated monitoring parameter based on the corrosion impact values.

17. A non-transitory computer-readable storage medium storing computer instructions, wherein when reading the computer instructions in the storage medium, a computer implements the method of claim 9.
